(19) United States
(12) Patent Application Publication
(10) Pub. No.: US 2012/0037678 A1
(43) Pub. Date: Feb. 16, 2012

(54) Bicycle carrying frame allowing the bicycles to cross over on a tail door of car from front to rear

(76) Inventor: Hung-Huan Hsu, Luzhu Township (TW)

(21) Appl. No.: 13/185,375

(22) Filed: Jul. 18, 2011

(30) Foreign Application Priority Data
Aug. 11, 2010 (TW) 099215343

(51) Int. Cl. B60R 9/00

(52) U.S. Cl. 224/534

(57) ABSTRACT

A bicycle carrying frame includes a main unit rack, front fork fixing seats, bicycle body support brackets, adjustment belts and hook-ring belts. The main unit rack is fixed on a tail door of car with the hook-ring belts; whereas, the front fork fixing seats and the bicycle body support brackets are fixed on the main unit rack. A bicycle front fork, with a front wheel being dismantled, is fixed on the front fork fixing seat and then a bicycle body is fixed on the bicycle body support bracket with the adjustment belt. As the front fork fixing seats are located alternately at different heights from front to rear, bicycle front forks with front wheels being dismantled are fixed and bicycle handles will not collide with each other. Therefore, a space for emplacing the bicycles is reduced that a car can be emplaced with plural bicycles for transportation with the car.

### BACKGROUND OF THE INVENTION

a) Field of the Invention

The present invention relates to a bicycle carrying frame allowing the bicycles to cross over on a tail door of car from front to rear, and more particularly to the bicycle carrying frame wherein front fork fixing seats are located alternately at different heights and from front to rear, so that plural sets of bicycle front forks, with front wheels being dismantled, can be fixed and bicycle handles can be prevented from colliding with each other. Therefore, a space for emplacing the bicycles can be reduced that a car body can be provided with plural bicycles to be transported with the car.

b) Description of the Prior Art

In recent years, a casual activity and walking out have been more and more popular and riding a bicycle has become one of the most favorite casual activities. However, it is an issue to be worried about by a car owner to figure out how to transport the bicycle to a destination with the car. As an existing bicycle carrying frame dedicated for the car is mostly hung on a top or tail of the car, it has a drawback of being very difficult to carry three or four bicycles to satisfy a need of riding the bicycles by a whole family and plural persons.

### SUMMARY OF THE INVENTION

Accordingly, the primary object of the present invention is to provide a bicycle carrying frame dedicated for a car, comprising front fork fixing seats, a main unit rack, bicycle body support brackets, adjustment belts and hook-ring belts, The bicycle carrying frame can be installed on a tail door of car to fix the bicycles, with that the front fork fixing seats which are located alternately at different heights from front to rear can prevent bicycle handles from colliding with each other and that spacing between the front fork fixing seats can be adjusted according to a practical need, thereby reducing a space for emplacing the bicycles.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of the present invention.

FIG. 2 shows an exploded view of the present invention.

FIG. 3 shows a schematic view of appearances of bicycle body support brackets that are folded, according to the present invention.

FIG. 4 shows a schematic view of practical installation of the present invention on a tail door of car.

FIG. 5 shows a schematic view of bicycle front forks that are installed at the front fork fixing seats, according to the present invention.

FIG. 5-1 shows a front planar view of the bicycle front forks that are installed at the front fork fixing seats, according to the present invention.

FIG. 6 shows a first schematic view of bicycles that are emplaced on a bicycle carrying frame, according to the present invention.

FIG. 7 shows a second schematic view of bicycles that are emplaced on a bicycle carrying frame, according to the present invention.

### DETAILED DESCRIPTION OF THE PREFERRED EMBODIMENTS

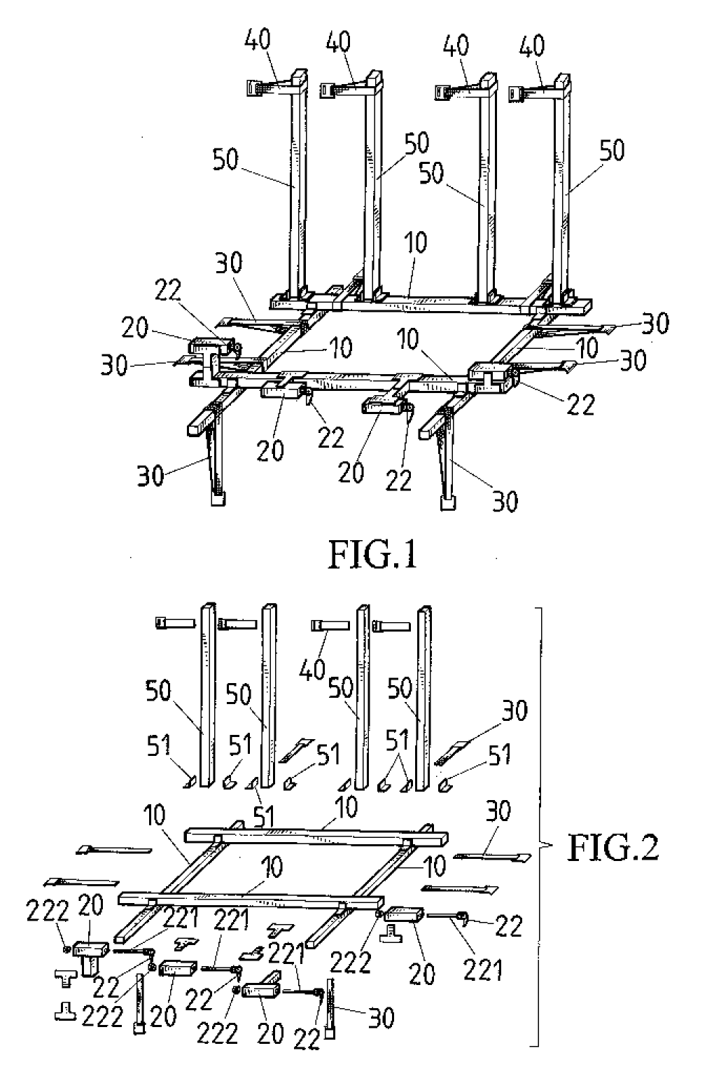

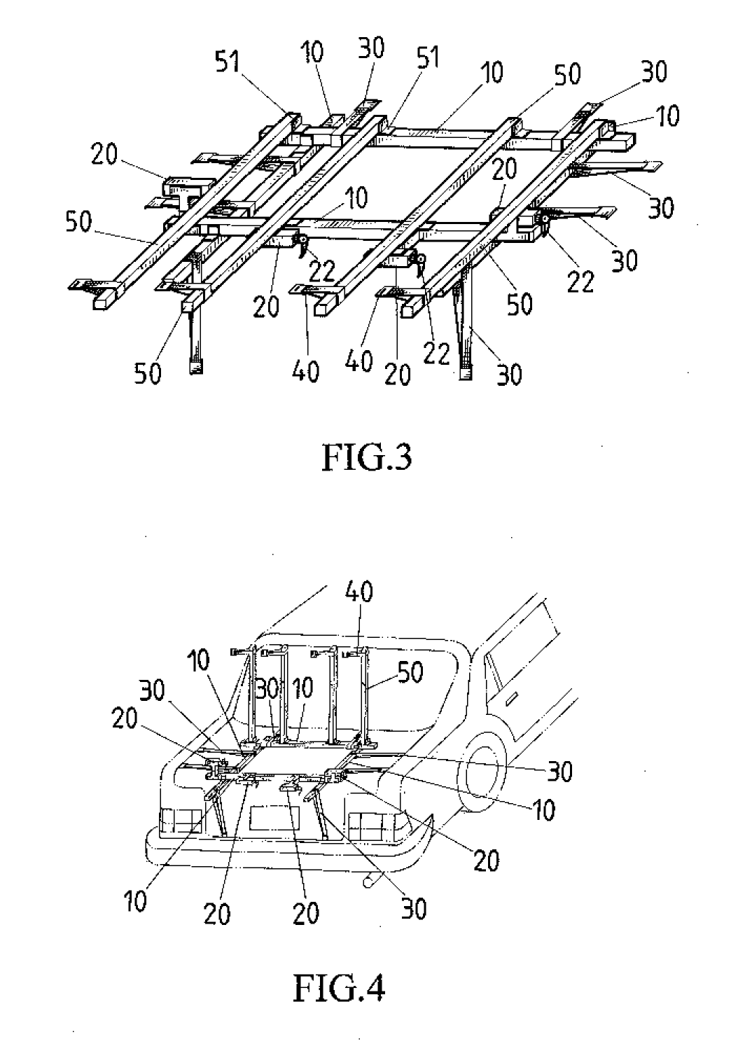

Referring to FIG. 1 and FIG. 2, the present invention is constituted by a main unit rack 10, at least one front fork fixing seat 20, at least one bicycle body support bracket 50, at least one adjustment belt 40 and at least one hook-ring belt 30. The main unit rack 10 is a #-shaped rack and after a tail door of car has been lifted open, the main unit rack 10 is hooked on the tail door with the hook-ring belts 30. The front fork seats 20 that are connected at proper locations of the main unit rack 10 are T-shaped seat units and are located alternately at different heights from front to rear. A bolt 221 of a front wheel fast dismantlement tool 22 penetrates the front fork fixing seat 20 and is then locked tightly with a nut 222. The bicycle body support bracket 50 can be pivoted on a proper location of the main unit rack 10 with a hinge 51. Referring to FIG. 3, after being folded, the bicycle body support bracket SO that supports a bicycle can be parallel to the main unit rack 10 and each bicycle body support bracket 50 is provided respectively with the adjustment belt 40 to fix the bicycle; whereas, the main unit rack 10 is provided with plural hook-ring belts 30.

Referring to FIG. 4, the bicycle carrying frame of the present invention utilizes plural hook-ring belts 30 to fix the main unit rack 10 on the tail door or car.

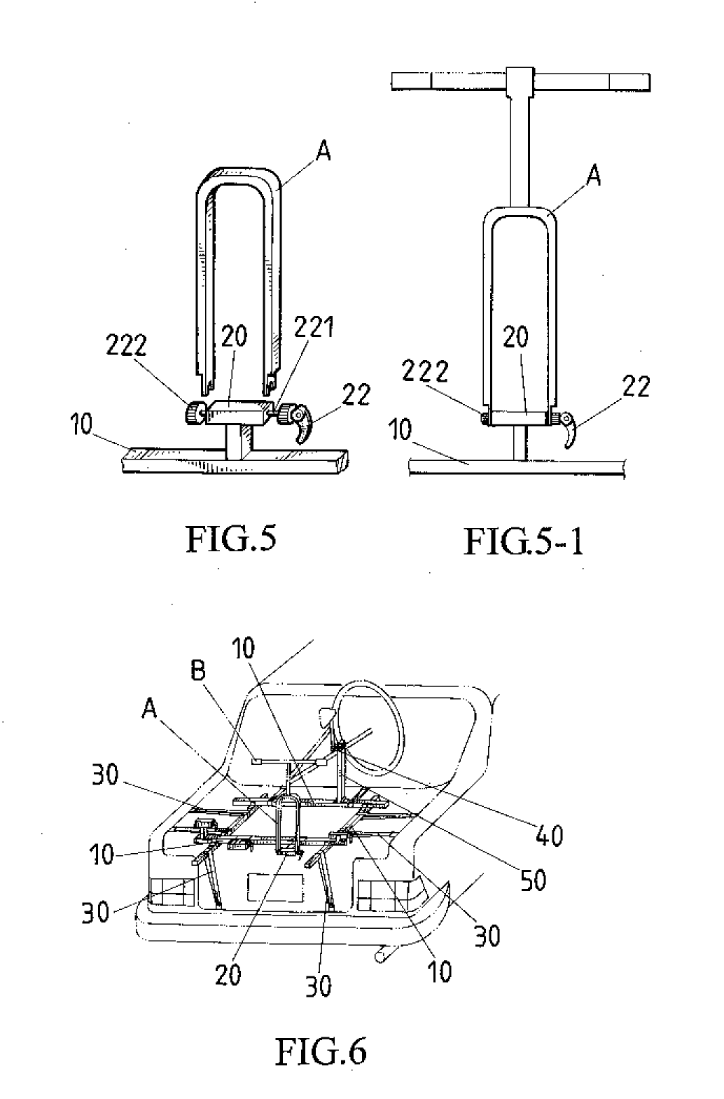

Referring to FIG. 5 and FIG. 5-1, a bicycle front fork A which is dismantled with a front wheel can cross over on the bolt 221 of the fast dismantlement tool 22 of the front fork fixing seat 20. The bolt 221 of the fast dismantlement tool 22 is locked tightly with the nut 222, so that the bicycle front fork A can be fixed on the front fork fixing seat 20.

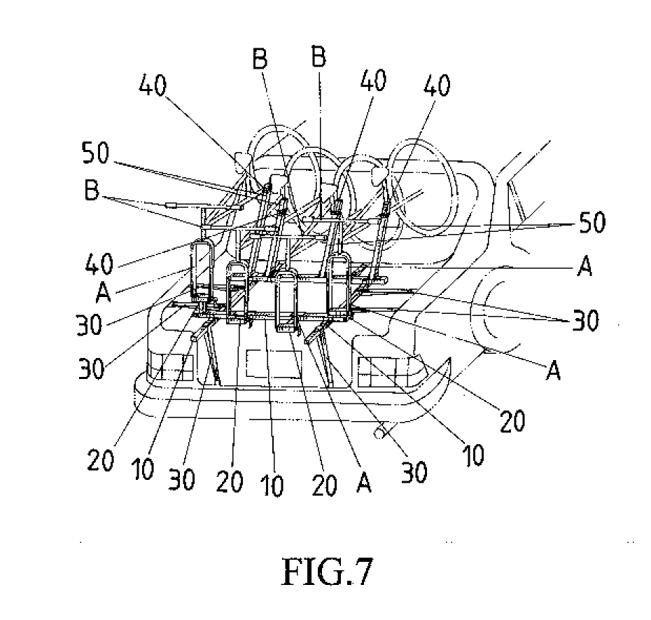

Referring to FIG. 6 and FIG. 7, for the front fork fixing seats 20 that are located alternately at different heights from front to rear, spacing between them can be adjusted according to a practical need. When the bicycle is installed on the tail door of car, as the front fork seats 20 that are located alternately at different heights from front to rear can stagger bicycle handles B, a configuration that can save the space most can be provided to emplace plural bicycles, thereby transporting the bicycles to a destination with the car.

Based on the description as detailed above, the present invention discloses the bicycle front fork fixing devices that are located alternately at different heights from front to rear, The devices can be installed on the tail door of car to provide the configuration that saves the space most to fix the bicycles, thereby emplacing plural bicycles that are transported to the destination with the car.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A bicycle carrying frame allowing the bicycles to cross over on a tail door of car from front to rear, comprising:
a main unit rack which is a #-shaped rack;
at least one front fork fixing seat which is installed on the main unit rack at a different height and is located alternately from front to rear;
at least one bicycle body support bracket which is fixed on a proper location of the main unit rack;
at least one adjustment belt which is used to fix a bicycle on the bicycle body support bracket; and
at least one hook-ring belt which is used to fix the main unit rack on a tail door of car.

2. The bicycle carrying frame allowing the bicycles to cross over on a tail door of car from front to rear, according to claim 1, wherein the front fork fixing seat is provided with a front wheel fast dismantlement tool, a bicycle front fork crosses over on a bolt of the fast dismantlement tool and is locked with a nut on the front fork fixing seat.

3. The bicycle carrying frame allowing the bicycles to cross over on a tail door of car from front to rear, according to claim 1, wherein the bicycle body support bracket is pivoted on the main unit rack with a hinge.
